(19) United States
(12) Patent Application Publication
(10) Pub. No.: US 2020/0033787 A1
(43) Pub. Date: Jan. 30, 2020

(54) DEVELOPER CARRYING DEVICE AND IMAGE FORMING APPARATUS

(71) Applicant: Oki Data Corporation, Tokyo (JP)

(72) Inventor: Toshimasa SHIOBARA, Tokyo (JP)

(21) Appl. No.: 16/446,552

(22) Filed: Jun. 19, 2019

(30) Foreign Application Priority Data
Jul. 26, 2018 (JP) 2018-140484

(51) Int. Cl. G03G 21/10; G03G 15/08; G03G 15/095; G03G 21/12

(52) U.S. Cl. CPC G03G 21/105; G03G 21/12; G03G 15/095; G03G 15/0813

(57) ABSTRACT

A developer carrying device for carrying a developer in a developer carrying path includes a developer carrying part that carries the developer in the developer carrying path; and a carrying drive part that drives the developer carrying part, wherein the developer carrying part includes: a carrying spiral that is formed by winding a wire rod into a coil shape and is driven by the carrying drive part; and a carrying auxiliary member that is arranged on an inner side of the carrying spiral, and is driven by the carrying drive part and assists carrying of the developer by the carrying spiral.

### TECHNOLOGY FIELD

The present invention relates to a developer carrying device that carries a developer, and relates to an image forming apparatus provided with the developer carrying device.

### BACKGROUND

Conventionally, an image forming apparatus such as a printer that uses a developer such as a toner to form an image and performs printing is provided with a developer carrying device that collects a waste toner not used in printing and carries the waste toner to a toner containing part. A developer carrying path of the developer carrying device is arranged to be curved avoiding units arranged inside the image forming apparatus in order to facilitate maintenance, replacement and the like of the units. Therefore, a configuration is adopted in which a waste toner is carried by rotating a carrying spiral which is formed by winding a wire rod into a coil shape so as to avoid a decrease in durability even when the developer carrying path is arranged to be curved (for example, see Japanese Patent Laid-Open Publication No. 2009-80433 (Patent Document 1)).

FIGS. 8A and 8B are explanatory diagrams of a developer carrying path of a conventional developer carrying device. FIG. 8A is a side view illustrating a portion of the developer carrying path of which a half of a carrying tube 316 on a front side of the sheet of the drawing is cut away in order to allow the inside of the developer carrying path to be clearly seen. FIG. 8B is an X-X cross-sectional view of FIG. 8A of the developer carrying path of which the half of the carrying tube 316 on the front side of the sheet of the drawing is not cut away. As illustrated in FIGS. 8A and 8B, in the developer carrying path 311 of the conventional developer carrying device, a carrying spiral 317 wound in a coil shape is arranged inside the carrying tube 316. Then, the carrying spiral 317 is rotated in an arrow CW direction by a motor or the like, and the waste toner inside the carrying tube 316 is carried.

### RELATED ART

[Patent Doc. 1] JP Laid-Open Patent Application Publication 2009-80433 SUBJECT(S) TO IMPROVE

However, in the above-described conventional developer carrying device, it may occur that the waste toner is not carried and stays. As a result, it may occur that a carrying force for carrying the waste toner is decreased and a sufficient toner carrying amount cannot be obtained.

The present invention is intended to solve such a problem, and is intended to provide a developer carrying device and an image forming apparatus that allow a toner carrying amount to be increased.

### SUMMARY

A developer carrying device, displayed in the application, for carrying a developer in a developer carrying path includes a developer carrying part that carries the developer in the developer carrying path; and a carrying drive part that drives the developer carrying part, wherein the developer carrying part includes: a carrying spiral that is formed by winding a wire rod into a coil shape and is driven by the carrying drive part; and a carrying auxiliary member that is arranged on an inner side of the carrying spiral, and is driven by the carrying drive part and assists carrying of the developer by the carrying spiral.

According to the present invention, the developer carrying part carrying the developer inside the developer carrying path, and the carrying drive part driving the developer carrying part are provided, and the developer carrying part is provided with the carrying spiral that is formed by winding a wire rod into a coil shape and is driven by the carrying drive part and the inner spiral or the core wire as a carrying auxiliary member that assists the carrying. Therefore, a waste toner retention area where the waste toner stays near the center of the developer carrying path does not occur, and, as a result, a carrying force for carrying the waste toner does not decrease, and, even when the developer is carried vertically from a lower side to an upper side, a sufficient toner carrying amount can be obtained.

### BRIEF DESCRIPTION OF THE DRAWINGS

FIG. 1 is an explanatory diagram of an image forming apparatus provided with a waste toner carrying device of a first embodiment.

FIG. 2 is an explanatory diagram of surroundings of the waste toner carrying device of the first embodiment.

FIGS. 3A and 3B are explanatory diagrams of a waste toner carrying path of the waste toner carrying device of the first embodiment.

FIG. 4 is an explanatory diagram of a waste toner carrying drive part and the waste toner carrying path of the waste toner carrying device of the first embodiment.

FIG. 5 shows evaluation results of a toner carrying amount of the waste toner carrying device of the first embodiment.

FIGS. 6A and 6B are explanatory diagrams of a waste toner carrying path of a waste toner carrying device of a second embodiment.

FIG. 7 is an explanatory diagram of a waste toner carrying drive part and the waste toner carrying path of the waste toner carrying device of the second embodiment.

FIGS. 8A and 8B are explanatory diagrams of a developer carrying path of a conventional developer carrying device.

FIG. 9A is an explanatory diagram of the developer carrying path in the first embodiment. FIG. 9B is an explanatory diagram of the developer carrying path in the second embodiment.

### DETAILED DESCRIPTION OF PREFERRED EMBODIMENT(S)

### First Embodiment

In the following, with regard to a first embodiment as a best mode for carrying out the present invention, configurations of a waste toner carrying device 100 as a developer carrying device and an image forming apparatus 200 are described. An element common to the drawings is denoted using the same reference numeral. In the following description, as a developer, a toner is described as an example. However, other developers may also be used.

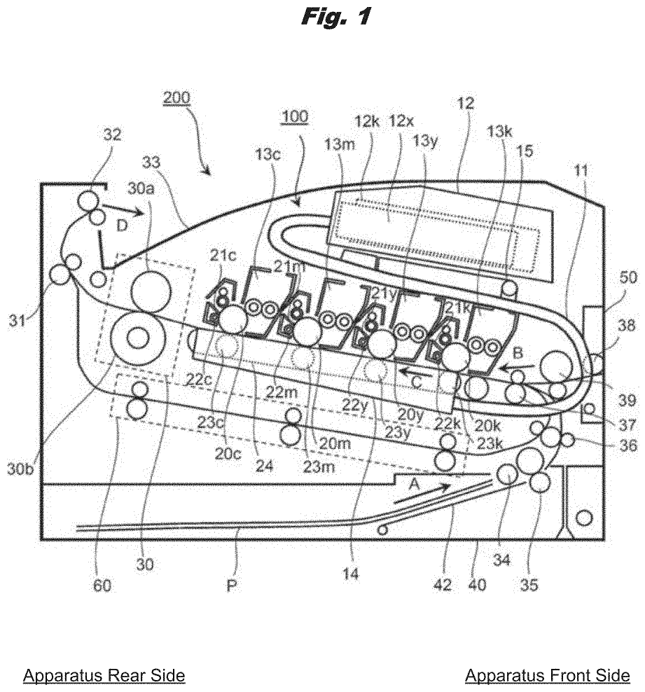

First, the configuration of the image forming apparatus 200 provided with the waste toner carrying device 100 is described. FIG. 1 is an explanatory diagram of the image forming apparatus provided with the waste toner carrying device of the first embodiment. The image forming apparatus 200 forms an image using a developer and performs printing on a sheet P. In the following, a right side of a drawing sheet is referred to as “a front side of the apparatus or apparatus front side” and a left side of the drawing sheet is referred to “a rear side of the apparatus or apparatus rear side.”

As illustrated in FIG. 1, the image forming apparatus 200 of the first embodiment has a sheet cassette 40 at a lower portion thereof and an optional tray attaching part 50 on the front side of the apparatus allowing an optional tray (not illustrated in the drawings) to be attached from outside. In this way, the image forming apparatus 200 has the sheet cassette 40 and the optional tray attaching part 50 on a carrying upstream side of a sheet P, and further has image forming units 13 and a fuser unit 30 on a carrying downstream side.

The sheet cassette 40 has a lifting and lowering plate 42 that pushes up a leading edge of the sheet P and presses the leading edge against a pickup roller 34. The lifting and lowering plate 42 is lifted when the sheet cassette 40 is attached, and the lifting and lowering plate 42 is lowered when the sheet cassette 40 is detached. Carrying roller pairs 35, 36, 37 for carrying the sheet P are arranged on a carrying downstream side of the sheet cassette 40. An optional tray pickup roller 38 for feeding out a sheet P from the optional tray and an optional tray carrying roller pair 39 for further carrying the fed out sheet P are arranged on a carrying downstream side of the optional tray attaching part 50. Image forming units 13k, 13y, 13m and 13c as image forming parts for forming toner images of multiple colors such as black (k), yellow (y), magenta (m) and cyan (c) are sequentially arranged on a carrying downstream side of the sheet cassette 40 and the optional tray attaching part 50 along a carrying direction of the sheet P indicated by an arrow C.

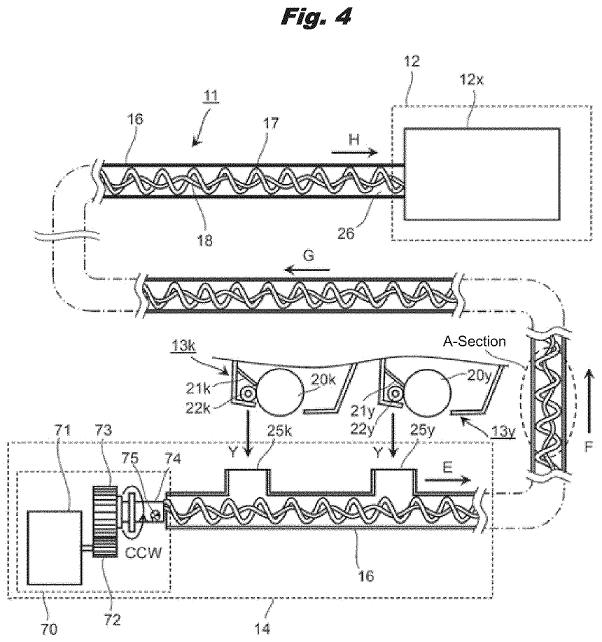

Among these, the image forming unit 13k on the most carrying upstream side, forms an image using a black (k) toner. In the image forming unit 13k, a development roller or the like for performing development using a black (k) toner is arranged at an upper portion. A photosensitive drum 20k, a cleaning blade 21k and a waste toner transfer mechanism 22k are arranged at a lower portion. The photosensitive drum 20k forms a black (k) toner image on a drum surface. The cleaning blade 21k removes toner that is not used in image formation and remains on the photosensitive drum 20k by scraping off the toner. The waste toner transfer mechanism 22k gathers the waste toner removed by the cleaning blade 21k by transferring the waste toner in a direction outward from the sheet of the drawing as a leftward direction with respect to the carrying direction of the sheet P. Then, the waste toner transfer mechanism 22k drops the waste toner into a receiving port 25k of a waste toner carrying path 11 as a developer carrying path to be described later using FIG. 4.

The same configuration also applies to the image forming units 13y, 13m and 13c. For simplicity, a detailed description thereof is omitted. In the following, when being collectively referred, the image forming units 13k, 13y, 13m and 13c are referred to as “the image forming units 13.”

The transfer rollers 23 are respectively arranged below the image forming units 13 as indicated by broken lines. The transfer rollers 23 respectively transfer toner images formed by the image forming units 13 onto the sheet P. The fuser unit 30 for fusing a toner image transferred onto the sheet P is arranged on a carrying downstream side of the image forming units 13. The fuser unit 30 includes a pressure application roller 30a and a heat application roller 30b inside which a heating part is provided. The fuser unit 30 fuses a toner image by pressing, with the pressure application roller 30a, the sheet P onto which the toner image has been transferred by the transfer rollers 23, and applying heat to the sheet P with the pressure application roller 30a.

Ejection roller pairs 31, 32 are arranged on a carrying downstream side of the fuser unit 30, and further, an ejection stacker 33 is arranged on a carrying downstream side. Further, a sheet reversing mechanism 60 that performs return carrying when double sided printing is performed is provided on a lower side of the image forming units 13.

Further, the image forming apparatus 200 of the first embodiment has a toner cartridge 12 as a developer containing part at an upper portion. Further, below the toner cartridge 12, the waste toner carrying device 100 as a developer carrying device is provided. The waste toner carrying device 100 includes: a waste toner carrying drive part 14 as a carrying drive part for carrying developer not used in image formation, that is, waste toner as used developer; and a waste toner carrying path 11 as a developer carrying path for carrying waste toner inside the waste toner carrying path 11.

In the toner cartridge 12, a waste toner containing part 12x for containing waste toner is arranged on a front side of the sheet drawing view as a left with respect to the carrying direction of the sheet P, and a toner containing part 12k (black) for containing unused toner is arranged on a back side of the sheet drawing view the drawing as a right side with respect to the carrying direction of the sheet P. A toner carrying unit 15 (to be described later) is arranged below the toner cartridge 12. The toner carrying unit 15 as a developer carrying path carries and supplies unused toners of the respective colors to be used in image formation from the toner containing part 12k (black) and the like to the image forming units 13.

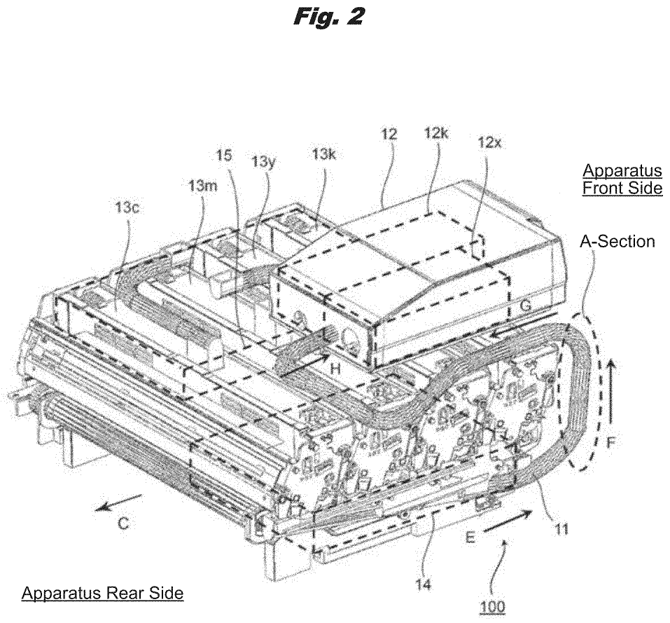

Next, a configuration of the toner cartridge 12 and the configuration of the waste toner carrying device 100 as a developer carrying device are described. FIG. 2 is an explanatory diagram of surroundings of the waste toner carrying device of the first embodiment. FIG. 2 illustrates the image forming units 13 inside the apparatus as viewed obliquely from above on the rear side of the apparatus of FIG. 1. The waste toner carrying device 100 includes the waste toner carrying path 11, a developer carrying part for carrying waste toner inside the waste toner carrying path 11, and the waste toner carrying drive part 14 driving the developer carrying part. As a result, the waste toner carrying device 100 can carry waste toner from the waste toner carrying drive part 14 to the waste toner containing part 12x of the toner cartridge 12. Here, the developer carrying part includes a carrying spiral 17 and an inner spiral 18.

As described above, the toner cartridge 12 includes the toner containing part 12k (black) and the waste toner containing part 12x. The toner containing part 12k (black) contains unused toner to be supplied to the image forming unit 13k. The waste toner containing part 12x is connected to a terminal end of the waste toner carrying path 11, and contains waste toner carried from the waste toner carrying drive part 14 via the waste toner carrying path 11.

As described above, the waste toner carrying device 100 includes the waste toner carrying drive part 14 and the waste toner carrying path 11. The waste toner carrying drive part 14 is arranged below the image forming units 13. The waste toner carrying drive part 14 drives the developer carrying part to carry waste toner removed by the cleaning blades 21k, 21y, 21m and 21c and gathered by the waste toner transfer mechanisms 22k, 22y, 22m and 22c to the waste toner containing part 12x.

As described above, the image forming units 13k, 13y, 13m and 13c as the image forming parts are sequentially arranged along the carrying direction of the sheet P indicated by the arrow C. The toner containing part 12k (black) and toner containing parts of the other colors (these toner containing parts 12y, 12m and 12c are not illustrated in the drawings) are arranged at upper portions of the image forming units 13k, 13y, 13m and 13c for supplying unused toners to the image forming units 13k, 13y, 13m and 13c. On the other hand, the waste toner transfer mechanisms 22k, 22y, 22m and 22c for gathering waste toner and the waste toner carrying drive part 14 for carrying the waste toner are provided at lower portions of the image forming units 13k, 13y, 13m and 13c.

A front end of the waste toner carrying path 11 is connected to the waste toner carrying drive part 14. The waste toner carrying path 11 is arranged extending from the waste toner carrying drive part 14 to the waste toner containing part 12x of the toner cartridge 12 which is at the terminal end of the waste toner carrying path 11, and is provided to carry waste toner collected from the image forming units 13 to the waste toner containing part 12x. In other words, the waste toner carrying device 100 connects between the image forming units 13 as the image forming parts and the toner cartridge 12 as the developer containing part, and carries waste toner as used developer to the toner cartridge 12. Therefore, the waste toner carrying path 11 needs to carry the waste toner in a vertical direction from a lower side to an upper side as indicated by an arrow F of a broken line A-section in FIG. 2.

On the other hand, as described using FIG. 1, the unused toner of the toner containing part 12k (black) is carried and supplied by the toner carrying unit 15 provided below the toner cartridge 12 from the toner containing part 12k (black) to the image forming unit 13k. Further, toners of the other colors (yellow (y), magenta (m) and cyan (c)) are respectively carried and supplied by the toner carrying unit 15 from toner cartridges of the respective colors (not illustrated in the drawings) to the image forming units 13.

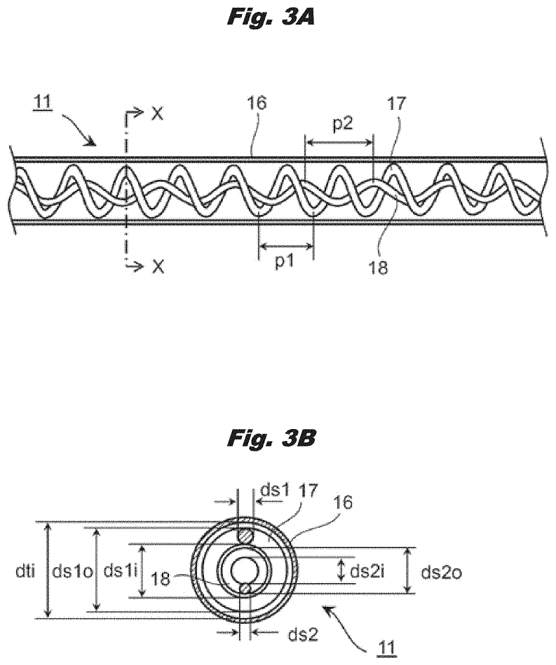

Next, a configuration of the waste toner carrying path 11 of the waste toner carrying device 100 of the first embodiment is described. FIGS. 3A and 3B are explanatory diagrams of the waste toner carrying path of the waste toner carrying device of the first embodiment. FIG. 3A is a side view illustrating a portion of the waste toner carrying path 11 of which a half of a carrying tube 16 on a front side of the drawing sheet view is cut away in order to allow the inside of the waste toner carrying path 11 to be clearly seen. FIG. 3B is an X-X cross-sectional view of FIG. 3A of the waste toner carrying path 11 of which the half of the carrying tube 16 on the front side of the drawing sheet view is not cut away (or a cross-section of the whole tube). In FIG. 3B, although the X-X cross section of the carrying spiral 17 is an ellipse, for convenience, the X-X cross section of the carrying spiral 17 is represented by a perfect circle.

As illustrated in FIGS. 3A and 3B, the waste toner carrying path 11 of the first embodiment has the carrying tube 16 that accommodates the developer carrying part, the carrying spiral 17 as the developer carrying part, and the inner spiral 18 as a carrying auxiliary member. The carrying tube 16 is formed of a tubular tube of a flexible elastic material such as a rubber, for example, a silicone rubber, and accommodates therein the carrying spiral 17 and the inner spiral 18, and carries the waste toner from the waste toner carrying drive part 14 as a front end to the waste toner containing part 12x of the toner cartridge 12 as a terminal end.

The carrying spiral 17 is formed by winding a wire rod into a coil shape, and carries the waste toner inside the carrying tube 16 by being rotationally driven by the waste toner carrying drive part 14. A material of the carrying spiral 17 is formed of, for example, SUS304. Similarly, the inner spiral 18 is formed by winding a wire rod into a coil shape, and carries the waste toner inside the carrying tube 16 by being rotationally driven by the waste toner carrying drive part 14. A rotation number of the inner spiral 18 (or rotation number per time) is the same as a rotation number of the carrying spiral 17. The inner spiral 18 has an outer diameter smaller than an inner diameter of the carrying spiral 17, and is arranged on an inner side of the carrying spiral 17. That is, the inner spiral 18 is provided on an inner side of the carrying spiral 17, and assists the carrying of the waste toner by the carrying spiral 17. A material of the carrying spiral 17 is also formed of, for example, SUS304.

In this way, the developer carrying part of the first embodiment is driven by the waste toner carrying drive part 14, and is provided with the carrying spiral 17 that is formed by winding a wire rod into a coil shape and the inner spiral 18 that assists the carrying.

In FIG. 3A, “p1” indicates a winding pitch of the carrying spiral 17, and “p2” indicates a winding pitch of the inner spiral 18. In the following, these are respectively referred to as a “carrying spiral pitch p1” and an “inner spiral pitch p2.” In FIG. 3B, “dti” indicates an inner diameter of the carrying tube 16. In the following, this is referred to as a “carrying tube inner diameter dti.”

“ds1” indicates a wire diameter of the carrying spiral 17. In the following, this is referred to as a “carrying spiral wire diameter ds1.” “ds1o” indicates an outer diameter of the carrying spiral 17, and “ds1i” indicates an inner diameter of the carrying spiral 17. In the following, these are respectively referred to as a “carrying spiral outer diameter ds1o” and a “carrying spiral inner diameter ds1i.” “ds2” indicates a wire diameter of the inner spiral 18. In the following, this is referred to as an “inner spiral wire diameter ds2.” “ds2o” indicates an outer diameter of the inner spiral 18, and “ds2i” indicates an inner diameter of the inner spiral 18. In the following, these are respectively referred to as an “inner spiral outer diameter ds2o” and an “inner spiral inner diameter ds2i.”

FIG. 4 is an explanatory diagram of the waste toner carrying drive part and the waste toner carrying path of the waste toner carrying device of the first embodiment. As illustrated in FIG. 4, a drive part 70 rotationally driving the carrying spiral 17 and the inner spiral 18 is provided in the waste toner carrying drive part 14. The drive part 70 includes a drive motor 71, a motor shaft gear 72, a spiral drive gear 73, a rotation shaft 74 and an end part fixing hole 75.

The drive motor 71 is a drive source which, under control of a control part (not illustrated in the drawings) of the image forming apparatus 200, rotationally drives the carrying spiral 17 and the inner spiral 18 in a counterclockwise (CCW) direction at a predetermined rotation speed. The drive motor 71 may be a DC motor or a stepping motor. When the carrying spiral 17 is wound in an opposite direction with respect to the direction illustrated in FIG. 4, the drive motor 71 rotationally drives the carrying spiral 17 and the inner spiral 18 in a clockwise (CW) direction.

The motor shaft gear 72 and the spiral drive gear 73 engage each other to rotationally drive the rotation shaft 74. The end part fixing hole 75 is provided in the rotation shaft 74, and end parts of the carrying spiral 17 and the inner spiral 18 on one side are fitted and fixed in the end part fixing hole 75. By having the above-described configuration, the carrying spiral 17 and the inner spiral 18 fixed to the rotation shaft 74 simultaneously rotate in an arrow CCW direction by rotationally driving the drive motor 71. On the other hand, four receiving ports 25 (among them, only the receiving ports 25k and 25y are illustrated in the drawing) are respectively provided at four places of the carrying tube 16 inside the waste toner carrying drive part 14.

As described above, the image forming units 13k, 13y, 13m and 13c (see FIG. 1) are sequentially arranged along the carrying direction of the sheet P. Toner remaining on the photosensitive drums 20k, 20y, 20m and 20c of the image forming units 13k, 13y, 13m and 13c is removed by the cleaning blades 21k, 21y, 21m and 21c, and is gathered by the waste toner transfer mechanisms 22k, 22y, 22m and 22c to the front side of the sheet of the drawing as a left side of the carrying direction of the sheet P and further falls down in a direction indicated by an arrow Y. The receiving ports 25 of the waste toner carrying path 11 are opening parts for receiving the waste toner.

The four receiving ports 25 (as described above, only the receiving ports 25k and 25y are illustrated in the drawings) at the four places respectively opposing the image forming units 13k, 13y, 13m and 13c of the respective colors (see FIG. 1) are sequentially arranged on the left side of the carrying direction of the sheet P. The waste toner carrying drive part 14 is also arranged on the left side of the carrying direction of the sheet P. Further, the waste toner carrying path 11 is curved in an S shape avoiding the units in the apparatus, and extends to a discharge port 26 connected to the waste toner containing part 12x of the toner cartridge 12.

By having the above-described configurations, the image forming apparatus 200 and the waste toner carrying device 100 of the first embodiment operate as follows. First, an operation of the image forming apparatus 200 of the first embodiment performing printing on the sheet P is described using FIG. 1. First, image data selected by a user from a host device such as a personal computer (not illustrated in the drawings) is transmitted to the image forming apparatus 200 via a USB cable or the like. When the image data is transmitted, the image forming apparatus 200 starts driving of the parts with a control part (not illustrated in the drawings) of the image forming apparatus 200. The image forming apparatus 200 feeds out the sheet P from the sheet cassette 40 in a direction indicated by an arrow A with the pickup roller 34 and carries the sheet P toward the image forming units 13 with the carrying roller pairs 35, 36, 37.

When the optional tray (not illustrated in the drawings) is attached to the optional tray attaching part 50, the sheet P of the optional tray is fed out by the optional tray pickup roller 38 in a direction indicated by an arrow B, and is carried by the optional tray carrying roller pair 39 toward the image forming units 13.

When the sheet P is carried in the direction indicated by the arrow C to the image forming units 13, electrostatic latent images are respectively formed on the photosensitive drums 20k, 20y, 20m and 20c by the image forming units 13 using toners of the respective colors. The image forming units 13 develop the electrostatic latent images formed on the photosensitive drums 20k, 20y, 20m and 20c with toners to form toner images. In this case, toner that is not used in image formation and remains on the photosensitive drums 20k, 20y, 20m and 20c is removed as waste toner by being scraped off by the cleaning blades 21k, 21y, 21m and 21c.

Further, the transfer rollers 23 and a transfer belt 24 transfer the toner images on the photosensitive drums 20k, 20y, 20m and 20c onto the sheet P carried thereto. The sheet P onto which a toner image has been transferred is carried to the fuser unit 30, and the transferred toner image is fused onto the sheet P. The fusion is performed by sandwiching and carrying the sheet P between the heat application roller 30b, which has been heated to a predetermined temperature, and the pressure application roller 30a. The sheet P onto which the toner image has been fused is carried by the ejection roller pairs 31, 32 and is ejected toward the ejection stacker 33 in a direction indicated by an arrow D. When double sided printing is performed, after printing has been performed on a front side of the sheet P by the above-described process, the sheet P is returned and carried by the sheet reversing mechanism 60, and the front and back sides of the sheet P are reversed and the sheet P is carried toward the image forming units 13, and printing on the back side of the sheet P is performed. When printing is performed on the sheet P fed out from the optional tray of optional tray attaching part 50, the same printing operation is performed. For simplicity, a detailed description thereof is omitted.

Next, an operation of the waste toner carrying device 100 is described in detail using FIG. 4. As described above, in the printing operation of the image forming apparatus 200, toner that is not used in image formation and remains on the photosensitive drums 20k, 20y, 20m and 20c is removed as waste toner by the cleaning blades 21k, 21y, 21m and 21c. The waste toner is transferred by the waste toner transfer mechanisms 22k, 22y, 22m and 22c and is gathered in the front side of the drawing sheet view as the left side of the carrying direction of the sheet P, and falls down as indicated by the arrow Y to the receiving ports 25 (only the receiving ports 25k and 25y are illustrated in the drawing) provided at a front end of the waste toner carrying path 11, and is collected in the waste toner carrying path 11.

The waste toner collected in the waste toner carrying path 11 is carried in a horizontal direction indicated by an arrow E by the carrying spiral 17 and the inner spiral 18 which simultaneously rotate in the CCW direction. Further, the waste toner is carried by the carrying spiral 17 and the inner spiral 18 in the vertical direction indicated by the arrow F of the broken line A-section from a lower side to an upper side to a predetermined height, and is subsequently carried in a horizontal direction indicated by an arrow G. Finally, the waste toner is carried in a horizontal direction indicated by an arrow H, and is carried to the discharge port 26 as a terminal end of the waste toner carrying path 11, and is contained in the waste toner containing part 12x provided in the toner cartridge 12.

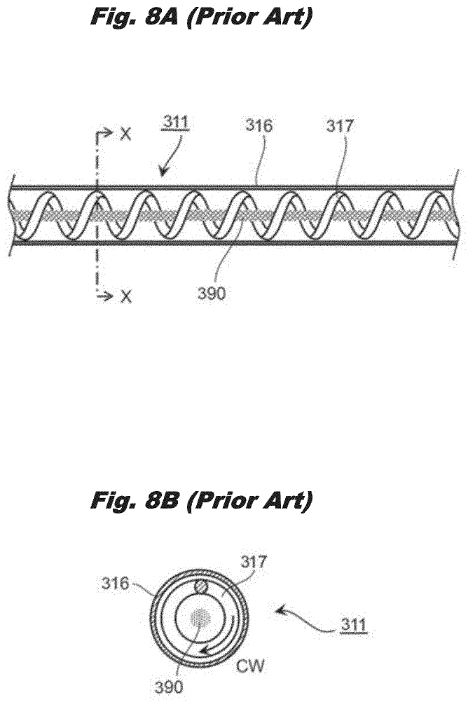

In this way, in the waste toner carrying device 100 of the first embodiment, the waste toner is collected in the waste toner carrying path 11 and is carried by the carrying spiral 17 and the inner spiral 18 which is provided on an inner side of the carrying spiral 17. In particular, when the waste toner is carried in the vertical direction indicated by the arrow F of the broken line A-section from the lower side to the upper side, waste toner entering and staying in a waste toner retention area 390 (see FIGS. 8A and 8B) near a center of the waste toner carrying path 11 can be carried by the inner spiral 18.

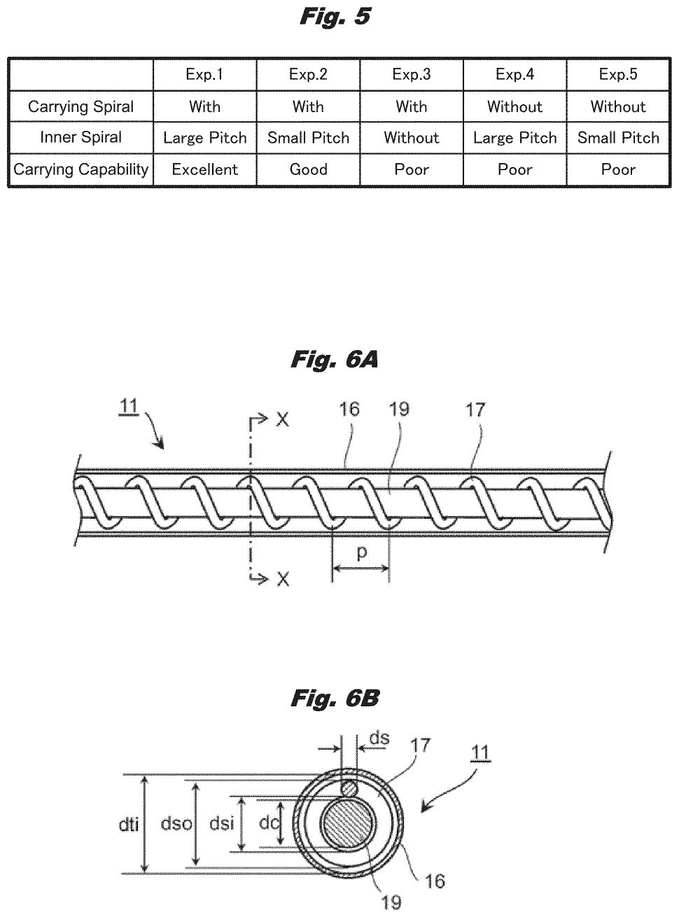

With the above-described configuration, results of evaluating a toner carrying amount of the waste toner carrying device 100 are described. FIG. 5 shows evaluation results of the toner carrying amount of the waste toner carrying device of the first embodiment. In the evaluation, the toner carrying amount is evaluated by varying the carrying spiral pitch p1, the inner spiral pitch p2, and the like. As a toner used in the evaluation, the black (k) toner was used. A polyester resin, a coloring agent, a charge control agent and a release agent were used as components, and hydrophobic silica was added as an external additive, and a developer having an average particle diameter of 7 μm obtained using a pulverizing method was used. The material of the carrying spiral 17 and the inner spiral 18 was SUS304.

The carrying tube inner diameter dti was 8 mm, and the carrying spiral wire diameter ds1 was 0.6 mm. The carrying spiral outer diameter ds1o was 7.4 mm, and the carrying spiral inner diameter ds1i was 6.2 mm. Further, the inner spiral wire diameter ds2 was 0.5 mm, the inner spiral outer diameter ds2o was 5.5 mm, and the inner spiral inner diameter ds2i was 4.5 mm. Further, the carrying spiral pitch p1 was 5.0 mm. The inner spiral pitch p2 was 10.0 mm in a case of a “large pitch,” and was 3.0 mm in a case of a “small pitch.” When the inner spiral pitch p2 was 5 mm and the carrying spiral pitch p1=the inner spiral pitch p2, the inner spiral 18 may jump out from gaps of the carrying spiral 17, and thus, evaluation under this condition is excluded.

Then, in Experiment 1, the carrying spiral 17 was arranged (referred with “With”) and the inner spiral pitch p2 was set to the “large pitch.” In Experiment 2, the carrying spiral 17 was arranged and the inner spiral pitch p2 was set to the “small pitch.” In Experiment 3, the carrying spiral 17 was arranged, and the inner spiral 18 was not arranged (referred with “Without”). In Experiment 4, the carrying spiral 17 was not arranged and the inner spiral pitch p2 was set to the “large pitch.” In Experiment 5, the carrying spiral 17 was not arranged and the inner spiral pitch p2 was set to the “small pitch.”

And, a carrying direction and a carrying distance were respectively set to the vertical direction and 170 mm (carrying in an upward direction at an inclination angle of 90 degrees), and the rotation speed of the carrying spiral 17 and the inner spiral 18 was set to 300 rpm. Under these conditions, a total amount of toner carried during 80 seconds when toner carrying was performed was measured and evaluated as a toner carrying amount M. Evaluation criteria were set as follows. When the toner carrying amount M>0.5 g/second, the evaluation was set to “0 (or Excellent);” when 0.5 g/second the toner carrying amount M 0.3 g/second, the evaluation result was set to “Δ (or Good);” and when the toner carrying amount M<0.3 g/second, the evaluation result was set to “x (or Poor).”

As a result, in the waste toner carrying device 100 of the first embodiment, as shown in FIG. 5, only in the case of Experiment 1, the evaluation result was “0.” That is, only in the case where the carrying spiral 17 having the carrying spiral pitch p1 of 5.0 mm was arranged and the inner spiral pitch p2 was set to the “large pitch,” a toner carrying criterion was satisfied. In other words, it was found that, in order to satisfy the toner carrying criterion, it is necessary to set the inner spiral pitch p2 to be larger than the carrying spiral pitch p1, and it is necessary to set the following Expression 1 as a condition.

(The inner spiral pitch p2)>(The carrying spiral pitch p1) (Expression 1).

Additionally, it is preferred that the inner spiral pitch p2 is 50% or more larger than the carrying spiral pitch p1.

A reason for this is that, as in Experiment 1, when the inner spiral pitch p2 is set to be larger than the carrying spiral pitch p1, an advancing speed of the inner spiral 18 is larger than an advancing speed of the carrying spiral 17. Therefore, it is thought that the toner staying near the center of the waste toner carrying path 11 can be reduced and a sufficient toner carrying amount can be obtained.

On the other hand, as in Experiment 2, when the inner spiral pitch p2 is set to be smaller than the carrying spiral pitch p1, the advancing speed of the inner spiral 18 is smaller than the advancing speed of the carrying spiral 17. Therefore, it is thought that the toner staying near the center of the waste toner carrying path 11 is increased and a sufficient toner carrying amount cannot be obtained. Further, when the inner spiral 18 was not arranged as in Experiment 3 and when the carrying spiral 17 was not arranged as in Experiment 4 and Experiment 5, regardless of presence or absence or the inner spiral 18 or the inner spiral pitch p2, a result was obtained that a sufficient toner carrying amount could not be obtained, and validity of the present evaluation was also confirmed.

As described above, according to the waste toner carrying device 100 and the image forming apparatus 200 of the first embodiment, the inner spiral 18 is arranged on the inner side of the carrying spiral 17 of the waste toner carrying path 11. Therefore, the waste toner entering and staying in the waste toner retention area 390 near the center of the waste toner carrying path 11 can be carried by the inner spiral 18. As a result, even when the waste toner is carried vertically upward from a lower side to an upper side, a sufficient toner carrying amount can be obtained. At the same time, it is not necessary to increase the carrying spiral wire diameter ds1 in order to obtain a sufficient toner carrying amount. Therefore, a load of the carrying spiral 17 can be reduced, and durability of the apparatus can be improved.

### Second Embodiment

In the waste toner carrying device 100 and the image forming apparatus 200 of the first embodiment, the configuration of the waste toner carrying path 11 is described as a configuration having the carrying tube 16, the carrying spiral 17 and the inner spiral 18. However, the following configuration may also be adopted. That is, instead of the inner spiral 18 of the waste toner carrying path 11 of the first embodiment, it is also possible to adopt a configuration in which a core wire 19 is arranged. Other configurations are the same as those of the waste toner carrying device 100 and the image forming apparatus 200 of the first embodiment.

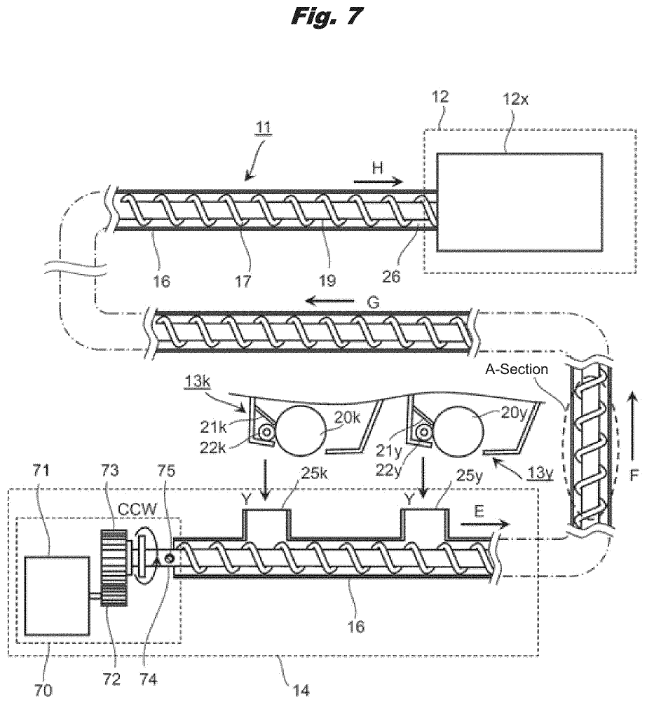

In the following, the configuration of the waste toner carrying path 11 as the developer carrying path of the waste toner carrying device 100 of the second embodiment is described. FIGS. 6A and 6B are explanatory diagrams of the waste toner carrying path of the waste toner carrying device of the second embodiment. FIG. 6A is a side view illustrating a portion of the waste toner carrying path 11 of which a half of the carrying tube 16 on a front side of the sheet of the drawing is cut away in order to allow the inside of the waste toner carrying path 11 to be clearly seen. FIG. 6B is an X-X cross-sectional view of FIG. 3A of the waste toner carrying path 11 of which the half of the carrying tube 16 on the front side of the sheet of the drawing is not cut away. In FIG. 6B, although the X-X cross section of the carrying spiral 17 is an ellipse, for convenience, the X-X cross section of the carrying spiral 17 is represented by a perfect circle.

As illustrated in FIGS. 6A and 6B, the waste toner carrying path 11 as the developer carrying path of the second embodiment has the carrying tube 16 that accommodates the developer carrying part, the carrying spiral 17 as the developer carrying part, and the core wire 19 as a carrying auxiliary member. Similar to the waste toner carrying device 100 of the first embodiment, the carrying tube 16 is formed of a tubular tube of a flexible elastic material such as a rubber, for example, a silicone rubber, and accommodates therein the carrying spiral 17 and the core wire 19, and carries the waste toner from a front end to a terminal end.

The carrying spiral 17 is formed by winding a wire rod into a coil shape, and carries waste toner collected between an inner wall of the carrying tube 16 and an outer diameter of the core wire 19 by being rotationally driven by the waste toner carrying drive part 14. A material of the carrying spiral 17 is formed of, for example, SUS304.

The core wire 19 extends near the center of the waste toner carrying path 11 on an inner side of the carrying spiral 17, that is, near the center of the carrying tube 16. As a result, the core wire 19 acts to eliminate waste toner from the waste toner retention area (see FIGS. 8A and 8B) near the center of the waste toner carrying path 11. Thus, the waste toner is collected between the inner wall of the carrying tube 16 and the outer diameter of the core wire 19. Therefore, the core wire 19 moves the waste toner in the carrying tube 16 in the direction of the carrying spiral 17 by being rotationally driven by the waste toner carrying drive part 14.

A rotation number of the core wire 19 is the same as a rotation number of the carrying spiral 17. The core wire 19 has an outer diameter smaller than an inner diameter of the carrying spiral 17, and is arranged on an inner side of the carrying spiral 17. That is, the core wire 19 is provided on an inner side of the carrying spiral 17, and assists the carrying of the waste toner by the carrying spiral 17. Since the waste toner carrying path 11 is arranged so as to be curved at some places, the core wire 19 is also preferably formed of an elastic material such as a silicone rubber. In this way, the developer carrying part of the second embodiment is driven by the waste toner carrying drive part 14, and is provided with the carrying spiral 17 that is formed by winding a wire rod into a coil shape and the core wire 19 that assists the carrying of the waste toner. It is preferred that the wire core is made of a material more flexible than that of the carrying spiral.

Further, in FIG. 6A, “p” indicates a winding pitch of the carrying spiral 17, which is, for example, about 5 mm similar to that in the first embodiment. In FIG. 6B, “dti” indicates an inner diameter of the carrying tube 16, which is, for example, about 8 mm. “ds” indicates a wire diameter of the carrying spiral 17, which is, for example, about 0.6 mm. “dso” indicates an outer diameter of the carrying spiral 17, which is, for example, about 7.4 mm, and “dsi” indicates an inner diameter of the carrying spiral 17, which is, for example, about 6.2 mm. “dc” indicates an outer diameter of the core wire 19, which is, for example, about 4 mm.

FIG. 7 is an explanatory diagram of the waste toner carrying drive part and the waste toner carrying path of the waste toner carrying device of the second embodiment. As illustrated in FIG. 7, a drive part 70 rotationally driving the carrying spiral 17 and the core wire 19 is provided in the waste toner carrying drive part 14. Similar to the first embodiment, the drive part 70 includes a drive motor 71, a motor shaft gear 72, a spiral drive gear 73, a rotation shaft 74 and an end part fixing hole 75.

The drive motor 71 is a drive source which, under control of a control part (not illustrated in the drawings) of the image forming apparatus 200, rotationally drives the carrying spiral 17 and the core wire 19 in the CCW direction at a predetermined rotation speed. The motor shaft gear 72 and the spiral drive gear 73 engage each other to rotationally drive the rotation shaft 74. The rotation shaft 74 is fixed to the core wire 19. Further, an end part of the carrying spiral 17 on one side is fitted and fixed in the end part fixing hole 75. By having such a configuration, the carrying spiral 17 and the core wire 19 fixed to the rotation shaft 74 simultaneously rotate in an arrow CCW direction by rotationally driving the drive motor 71.

On the other hand, similar to the first embodiment, four receiving ports 25 (only the receiving ports 25k and 25y are illustrated in the drawing) are respectively provided at four places of the carrying tube 16 inside the waste toner carrying drive part 14. Toner remaining on the photosensitive drums 20k, 20y, 20m and 20c of the image forming units 13k, 13y, 13m and 13c as an image forming means is removed by the cleaning blades 21k, 21y, 21m and 21c, and is gathered as waste toner by the waste toner transfer mechanisms 22k, 22y, 22m and 22c to the front side of the sheet of the drawing as a left side of the carrying direction of the sheet P and further falls down in a direction indicated by an arrow Y.

The four receiving ports 25 (only the receiving ports 25k and 25y are illustrated in the drawings) at the four places of the waste toner carrying path 11 are opening parts for receiving the waste toner. The four receiving ports 25 (only the receiving ports 25k and 25y are illustrated in the drawings) at the four places respectively opposing the image forming units 13k, 13y, 13m and 13c as the image forming parts of the respective colors (see FIG. 1) are sequentially arranged on the left side of the carrying direction of the sheet P. The waste toner carrying drive part 14 is also arranged on the left side of the carrying direction of the sheet P.

Further, the waste toner carrying path 11 is curved in an S shape avoiding the units in the apparatus, and extends to a discharge port 26 as a terminal end connected to the waste toner containing part 12x of the toner cartridge 12. The carrying spiral 17 and the core wire 19 are described to be simultaneously rotationally driven. However, it is also possible to adopt a configuration in which only the carrying spiral 17 is rotated by the drive part 70 and the core wire 19 is rotated by the rotation of the carrying spiral 17.

By having the above-described configurations, the image forming apparatus 200 and the waste toner carrying device 100 of the second embodiment operate as follows. In the second embodiment, operations of the waste toner carrying drive part 14 and the waste toner carrying path 11 are different from those of the first embodiment, and other operations are the same as the operations of the waste toner carrying device 100 and the image forming apparatus 200 of the first embodiment. Therefore, for simplicity, description about the same operations is omitted.

In the following, the operation of the waste toner carrying device 100 of the second embodiment is described in using FIG. 7. In the printing operation of the image forming apparatus 200, toner that is not used in image formation and remains on the photosensitive drums 20k, 20y, 20m and 20c is removed as waste toner by the cleaning blades 21k, 21y, 21m and 21c. The waste toner is transferred by the waste toner transfer mechanisms 22k, 22y, 22m and 22c and is gathered to the left side of the carrying direction of the sheet P, and falls down in a direction indicated by the arrow Y to the receiving ports 25 (only the receiving ports 25k and 25y are illustrated in the drawing) provided at a front end of the waste toner carrying path 11, and is collected between the inner wall of the carrying tube 16 and the outer diameter of the core wire 19.

The waste toner collected between the inner wall of the carrying tube 16 and the outer diameter of the core wire 19 is carried in a direction indicated by an arrow E by the carrying spiral 17 which simultaneously rotates with the core wire 19 in the CCW direction. Further, the waste toner is carried by the carrying spiral 17 in a vertical direction indicated by an arrow F of a broken line A-section from a lower side to an upper side to a predetermined height, and is subsequently carried in a horizontal direction indicated by an arrow G. Finally, the waste toner is carried in a horizontal direction indicated by an arrow H to the discharge port 26 as a terminal end of the waste toner carrying path 11, and is contained in the waste toner containing part 12x provided in the toner cartridge 12.

In this way, in the waste toner carrying device 100 of the second embodiment, the waste toner is collected between the inner wall of the carrying tube 16 and the outer diameter of the core wire 19 and is carried by the carrying spiral 17. Therefore, even when the waste toner is carried in the vertical direction indicated by the arrow F of the broken line A-section from the lower side to the upper side, the waste toner does not enter and stay in the waste toner retention area 390 (see FIGS. 8A and 8B) near the center of the waste toner carrying path 11, and a sufficient toner carrying amount can be obtained by the carrying spiral 17.

As described above, according to the waste toner carrying device 100 and the image forming apparatus 200 of the second embodiment, the core wire 19 is arranged on the inner side of the carrying spiral 17 of the waste toner carrying path 11. Therefore, the waste toner does not enter and stay in the waste toner retention area 390 near the center of the waste toner carrying path 11 and carrying efficiency can be improved. As a result, even when the waste toner is carried vertically upward from a lower side to an upper side, a sufficient toner carrying amount can be obtained by the carrying spiral 17. At the same time, it is not necessary to increase the carrying spiral wire diameter ds in order to obtain a sufficient toner carrying amount. Therefore, a load of the carrying spiral 17 can be reduced, and durability of the apparatus can be improved.

### Modified Embodiment 1

The present invention is not limited to the above embodiments. Based on the spirit of the present invention, modifications are possible, which are not to be excluded from the scope of the present invention. For example, in the description of the above embodiments, as the image forming apparatus 200, a printer is described as an example. However, it is also possible that the image forming apparatus 200 is a copying machine, a facsimile, or a multifunction machine. Further, in the description of the above embodiments, an electrophotographic image forming apparatus is described as an example. However, it is also possible that the image forming apparatus 200 is an electrostatic recording image forming apparatus, an electrostatic printing image forming apparatus, or a toner jet image forming apparatus.

### Modified Embodiment 2

Further, in the description of the above embodiments, a mode is described in which the waste toner carrying device 100 is provided inside the image forming apparatus 200. However, it is also possible to adopt a mode in which the waste toner carrying device 100 is provided outside the image forming apparatus 200.

### Modified Embodiment 3

Further, in the description of the above embodiments, the waste toner carrying device 100 configured by the waste toner carrying drive part 14 and the waste toner carrying path 11 is described as an example. However, it is also possible to apply the present invention to the toner carrying unit 15 (see FIG. 1) as a developer carrying device supplying unused toner to the image forming units 13. In this case, the toner carrying unit 15 as a developer carrying path is provided between the toner containing part 12k containing unused toner as a developer and the image forming units 13 using unused toner to form an image. Then, the developer carrying part carries the unused toner from the toner containing part 12k to the image forming units 13.

### Modified Embodiment 4

Further, in the description of the first embodiment, an embodiment in which the waste toner is carried by the carrying spiral 17 and the inner spiral 18 is described. However, it is also possible that an inner spiral (not illustrated in the drawings) is further provided on an inner side of the inner spiral 18, or the core wire 19 described in the second embodiment is provided on the inner side of the inner spiral 18.

### Additional Explanation

In the present invention, the inner spiral 18 and the core wire 19 are both regarded as the carrying auxiliary member. Accordingly, the outer diameter (ds2i) of the inner spiral 18 and the outer diameter (dc) of the core wire 19 are both regarded as an outer diameter of the carrying auxiliary member.

Further, in a practical view, the inner spiral 17, the carrying spiral 18 and the wire core 19 are preferred to rotate at 100 rpm (or rotation per minute) or more. The rotation speeds of these items (17-19) may be the same or may vary depending on a diameter of the tube, or toner's characteristics.

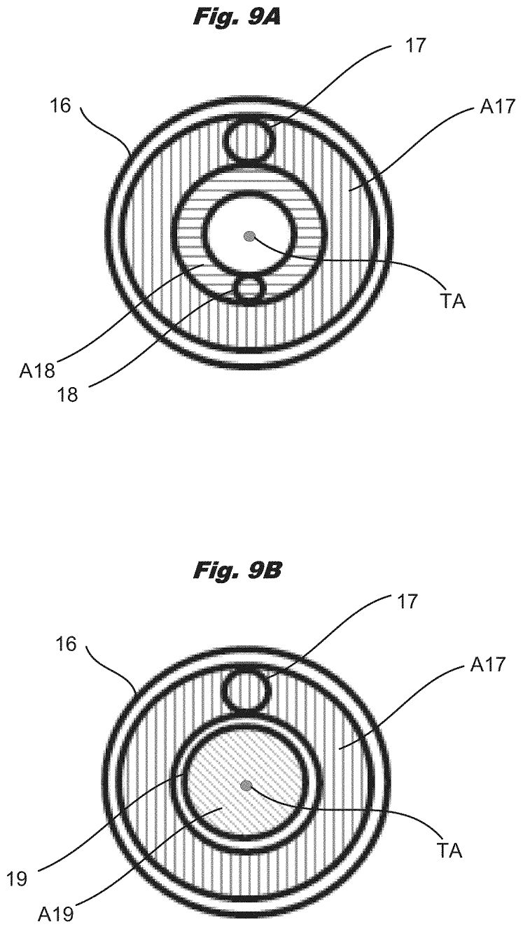

(Explanations of FIGS. 9A and 9B)

FIG. 9A illustrates a sectional view, which is cut perpendicular to the tube axis (TA), of the first embodiment in which a carrying spiral area A17 and an inner spiral area A18 are shown with different hatching. The vertical hatching indicates the area A17. The lateral hatching indicates the area A18. The carrying spiral area means an area where the carrying spiral 17 runs or occupies while rotating around the tube axis TA. The inner spiral area means another area where the inner spiral 18 runs or occupies while rotating. Herein, it is preferred that the area A17 is ranged from 16% to 35% with respect to the total sectional area of the tube, and the area A18 is ranged from 5% to 25% with respect to the total sectional area of the tube.

FIG. 9B illustrates a sectional view in which a carrying spiral area A17 and a core wire area A19 are shown with different hatching. The vertical hatching indicates the area A17. The diagonal hatching indicates the area A19. The carrying spiral area means the same above. The core wire area means another area where the core wire 19 is present while rotating. Herein, it is preferred that the area A17 is ranged from 16% to 35% with respect to the total sectional area of the tube, and the area A19 is ranged from 15% to 35% with respect to the total sectional area of the tube.

Considering that the inner spiral 18 and the core wire 19 are both regarded as the carrying auxiliary member, it is preferred that an area where the carrying auxiliary member runs or occupies in the sectional view while rotating is regarded as an auxiliary area and ranged from 5% to 35% with respect to the total sectional area of the tube.

Further, in the first embodiment, it is preferred to arrange the tube 16, the carrying spiral 17 and the inner spiral 18 in order not to contact each other while rotating. In the second embodiment, it is preferred to arrange the tube 16, the carrying spiral 17 and the core wire 19 in order not to contact each other while rotating. Accordingly, an outer tip of the carrying spiral may be smaller than an internal diameter of the tube. An outer tip of the inner spiral may be smaller than an inner tip of the carrying spiral. Also, an outer tip of the core wire may be smaller than the inner tip of the carrying spiral. These features are shown, for example, in FIG. 3B and FIG. 6B.

What is claimed is:

1. A developer carrying device for carrying a developer in a developer carrying path, comprising:
a developer carrying part that carries the developer in the developer carrying path; and
a carrying drive part that drives the developer carrying part, wherein
the developer carrying part includes:
a carrying spiral that is formed by winding a wire rod into a coil shape and is driven by the carrying drive part; and
a carrying auxiliary member that is arranged on an inner side of the carrying spiral, and is driven by the carrying drive part and assists carrying of the developer by the carrying spiral.

2. The developer carrying device according to claim 1, wherein
the developer carrying path is composed with a longitudinal tube that extends in a longitudinal direction along which the developer is carried, and has an inner circumference centering at a tube axis,
the carrying spiral rotates around the tube axis while being driven by the carrying drive part, the carrying auxiliary member rotates around the tube axis, which is the same as the carrying spiral, while being driven by the carrying drive part,
seen from a sectional view of the developer carrying path, which is cut perpendicular to the tube axis,
an carrying spiral area (A17) is defined at which the carrying spiral occupies while rotating,
an auxiliary area (A18, A19) is defined at which the carrying auxiliary member occupies while rotating, and
the carrying spiral area is ranged from 26% to 36% with respect to a total sectional area of the developer carrying path, and
the auxiliary area is ranged from 5% to 35% with respect to a total sectional area of the developer carrying path.

3. The developer carrying device according to claim 2, wherein
the developer carrying path is provided between a developer containing part containing the developer and an image forming part using the developer to form an image.

4. The developer carrying device according to claim 3, wherein
the carrying auxiliary member is an inner spiral that is wound in a coil shape and is arranged inside the carrying spiral.

5. The developer carrying device according to claim 4, wherein
seen from the sectional view of the developer carrying path, an inner spiral area (A18) is defined at which the inner spiral occupies while rotating, and
the inner spiral area is ranged from 5% to 25% with respect to a total sectional area of the developer carrying path.

6. The developer carrying device according to claim 4, wherein
a winding pitch of the inner spiral is larger than a winding pitch of the carrying spiral, and
the winding pitch of the inner spiral is determined by a longitudinal length per one rotation of the inner spiral, and
the winding pitch of the carrying spiral is determined by a longitudinal length per one rotation of the carrying spiral.

7. The developer carrying device according to claim 6, wherein
the winding pitch of the inner spiral is 50% or more larger than the winding pitch of the carrying spiral.

8. The developer carrying device according to claim 3, wherein
the carrying auxiliary member is a core wire that is arranged on an inner side of the carrying spiral, the core wire being in a wire shape, made of a material more flexible than a material of the carrying spiral, and centered at the tube axis.

9. The developer carrying device according to claim 6, wherein
the developer carrying part further includes a core wire that is arranged inside the inner spiral, the core wire being in a wire shape and centered at the tube axis.

10. The developer carrying device according to claim 3, wherein
the developer containing part is positioned above the image forming part, being connected to the image forming part with the developer carrying path such that the carrying spiral and the carrying auxiliary member carry the developer upward through the developer carrying path.

11. The developer carrying device according to claim 4, wherein
the developer is waste toner that is not consumed by the image forming part in image formation, and
the developer carrying part carries the waste toner from the image forming part to the developer containing part.

12. The developer carrying device according to claim 4, wherein
the developer is unused toner to be used by the image forming part in image formation, and
the developer carrying part carries the unused toner from the developer containing part to the image forming part.

13. An image forming apparatus, comprising:
the developer carrying device according to claim 1.

14. The image forming apparatus according to claim 13, further comprising:
an image forming part that performs an image formation using toner that is the developer, wherein
the carrying path is connected from a receiving port (25) that receives a wasted toner to a developer containing part that is designed to contain the wasted toner, wherein
the receiving port is an opening that is positioned below the image forming part such that the wasted toner, which is not consumed for the image formation, falls from the image forming part, passing through the receiving part and reaching inside the tube, and the developer containing part is positioned above the image forming part, and
the carrying spiral and the carrying auxiliary member are arranged entirely from the receiving port to the developer containing part such that the wasted toner received at the receiving port is carried to the developer containing part from the receiving port.

15. The image forming apparatus according to claim 14, wherein
the carrying path has an upright section (A-section), which extends in a vertical direction parallel to the gravity, and
the carrying spiral and the carrying auxiliary member rotate at 100 rpm or faster.

16. The image forming apparatus according to claim 15, further comprising:
another developer containing part that contains the toner, which has not be used, and supplies the toner to the image forming part, wherein
the developer containing part, which collects the wasted toner, and the another developer containing part, which supplies the toner, are integrally formed together to be adjacent each other.
